(19) United States
(12) Patent Application Publication
(10) Pub. No.: US 2014/0198082 A1
(43) Pub. Date: Jul. 17, 2014

(54) METHOD FOR CORRECTING REAL AND DIGITAL INK

(71) Applicant: RESEARCH IN MOTION LIMITED, Waterloo, CA (US)

(72) Inventors: Robert Felice MORI, Palo Alto, CA (US); Jonathan Haking LO, Foster City, CA (US)

(73) Assignee: RESEARCH IN MOTION LIMITED, Waterloo (CA)

(21) Appl. No.: 13/742,002

(22) Filed: Jan. 15, 2013

(51) Int. Cl. G06F 3/0354

(52) U.S. Cl. CPC G06F 3/03545
USPC 345/179

(57) ABSTRACT

An electronic drawing system configured to edit a physical drawing and communicate the edit to a host electronic device that renders a digital rendition of the physical drawing. The electronic system device includes a control circuit configured to communicate with an element that enables erasing at least a portion of the physical drawing. The control circuit generates at least one signal representative of the erasing, where the at least one signal is capable of being processed to edit the digital representation corresponding to the erasing.

### FIELD OF THE DISCLOSURE

The present disclosure relates generally to electronic devices, and more particularly, to touch-sensitive surfaces that operate in conjunction with a stylus.

### BACKGROUND

Many electronic devices include a touch-sensitive surface. Touch-sensitive surfaces are typically configured to be responsive to fingertip touch, and/or to enable inputs to be made via a stylus. A stylus typically comprises a pencil-like hand-held implement having at least one of its ends shaped and configured to have a small contact point with a touch-sensitive surface. In some cases the stylus is a very simple device (such as an elongated plastic shaft) and may be passive in nature, while in other cases metals or a variety of materials may be utilized and transmitters may be employed in an active stylus that transmits a signal that is processed by a host device.

When using a digital sketching system with real paper and ink, and then transferring the image to a digital format, any edits made to the digital rendition cannot be reflected on the original, nor can edits made on the paper version be correspondingly implemented on the digital version.

It would therefore be desirable to provide a methodology and device that enables a user to simultaneously effect changes on a digital rendition of a paper drawing such that the digital image accurately reflects any changes that are made to the original. In this regard, digital drawings have a more “natural” feel and extra time to effect similar edits those made to a physical version is not required.

### BRIEF DESCRIPTION OF THE DRAWINGS

FIG. 1 is a schematic of a host electronic device configured for carrying out aspects of the disclosure;

FIG. 2 is a schematic of an illustrative drawing system in accordance with an aspect of the disclosure;

FIG. 3 is a flow-diagram of a process in accordance with an aspect of the disclosure; and

FIG. 4 is a schematic of the system shown in FIG. 2 with a pen configured in erasure mode in accordance with an aspect of the disclosure.

### DETAILED DESCRIPTION

For simplicity and clarity of illustration, reference numerals may be repeated among the figures to indicate corresponding or analogous elements. Numerous details are set forth to provide an understanding of the illustrative embodiments described herein. The embodiments may be practiced without these details. In other instances, well-known methods, procedures, and components have not been described in detail to avoid obscuring the disclosed embodiments. The description is not to be considered as limited to the scope of the embodiments shown and described herein.

The embodiments described herein generally relate to electronic devices. Examples of electronic devices include mobile (wireless) communication devices such as smartphones, tablets, wireless organizers, personal digital assistants and wireless-enabled notebook computers. These examples are intended to be non-limiting. In accordance with an aspect of the disclosure, an electronic drawing system (and methodology for using the same) is configured to edit a physical drawing and communicate the edit to a host electronic device that renders a digital rendition of the physical drawing. The electronic drawing system includes a control circuit configured to communicate with an element that enables erasing at least a portion of the physical drawing. The control circuit generates at least one signal representative of the erasing, where the at least one signal is capable of being processed to edit the digital representation corresponding to the erasing.

These teachings are highly flexible in practice and will accommodate a wide variety of different types and sizes of touch-sensitive surfaces and electronic input/drawing devices. The concepts set forth herein are also easily implemented and can readily serve to further leverage the continued utility of numerous existing designs in these regards.

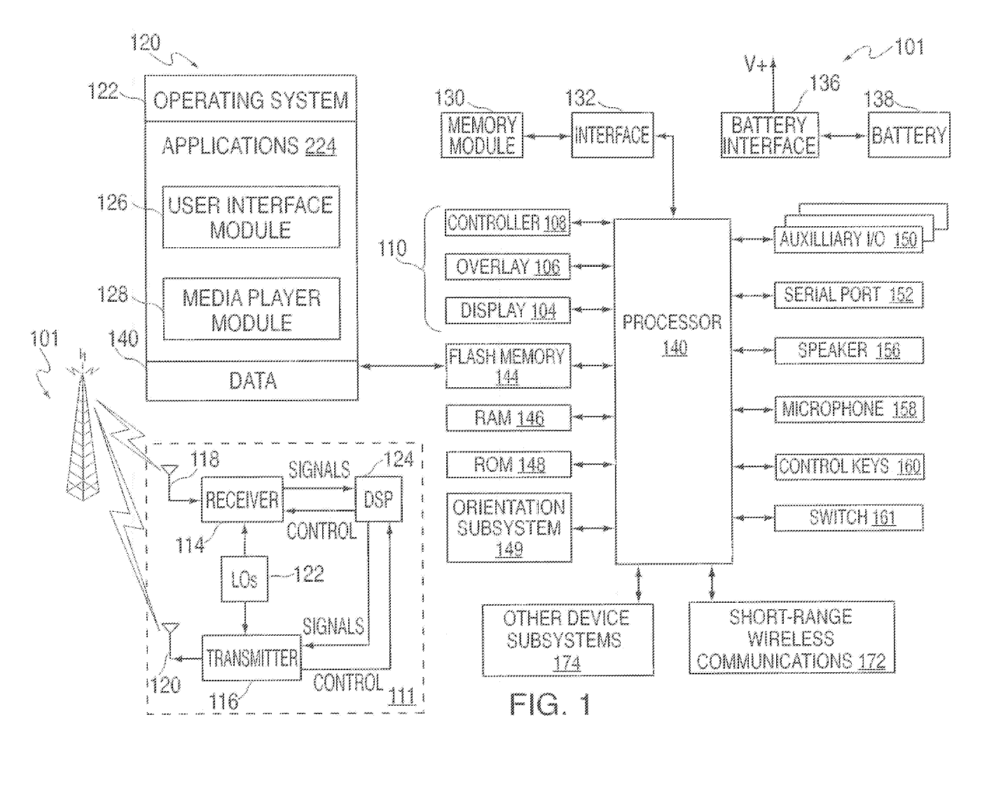

Reference is now made to FIG. 1, which illustrates a host electronic device, such as an electronic communication device 101 in which exemplary embodiments described in the present disclosure can be applied. The device is shown and described as a mobile communication device which, in various embodiments, may be a data communication device, a multiple-mode communication device configured for both data and voice communication, a smartphone, a mobile telephone or a PDA (personal digital assistant) enabled for wireless communication, or a computer system with a wireless modem. Alternatively, the host electronic device 101 may be Desktop PC or laptop.

The mobile communication device 101 includes a controller comprising at least one processor 140 such as a microprocessor which controls the overall operation of the mobile communication device 101, and a wireless communication subsystem 111 for exchanging radio frequency signals with a wireless network. The processor 140 interacts with the communication subsystem 111 which performs communication functions. The processor 140 interacts with additional device subsystems including a display (screen) 104, such as a liquid crystal display (LCD) screen, with a touch-sensitive input surface or overlay 106 connected to an electronic controller 108 that together make up a touchscreen display 110. The touch-sensitive overlay 106 and the electronic controller 108 provide a touch-sensitive input device and the processor 140 interacts with the touch-sensitive overlay 106 via the electronic controller 108.

The processor 140 interacts with additional device subsystems including flash memory 144, random access memory (RAM) 146, read only memory (ROM) 148, auxiliary input/output (I/O) subsystems 150, data port 152 such as serial data port, such as a Universal Serial Bus (USB) data port, speaker 156, microphone 158, control keys 160, switch 161, short-range communication subsystem 172, and other device subsystems generally designated as 174. Some of the subsystems shown in FIG. 1 perform communication-related functions, whereas other subsystems may provide “resident” or on-device functions.

The communication subsystem 111 includes a receiver 114, a transmitter 116, and associated components, such as one or more antenna elements 118 and 121, local oscillators (LOs) 122, and a processing module such as a digital signal processor (DSP) 124. The antenna elements 118 and 121 may be embedded or internal to the mobile communication device 101 and a single antenna may be shared by both receiver and transmitter, as is known in the art. As will be apparent to those skilled in the field of communication, the particular design of the wireless communication subsystem 121 depends on the wireless network 101 in which mobile communication device 101 is intended to operate.

The mobile communication device 101 may communicate with any one of a plurality of fixed transceiver base stations of the wireless network within its geographic coverage area. The mobile communication device 101 may send and receive communication signals over the wireless network 101 after the required network registration or activation procedures have been completed. Signals received by the antenna 118 through the wireless network 101 are input to the receiver 114, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 124. In a similar manner, signals to be transmitted are processed, including modulation and encoding, for example, by the DSP 124. These DSP-processed signals are input to the transmitter 116 for digital-to-analog (D/A) conversion, frequency up conversion, filtering, amplification, and transmission to the wireless network 101 via the antenna 121. The DSP 124 not only processes communication signals, but may also provide for receiver and transmitter control. For example, the gains applied to communication signals in the receiver 114 and the transmitter 116 may be adaptively controlled through automatic gain control algorithms implemented in the DSP 124.

The processor 140 operates under stored program control and executes software modules 120 stored in memory such as persistent memory, for example, in the flash memory 144. As illustrated in FIG. 1, the software modules 120 comprise operating system software 122, software applications 124 comprising a user interface module 126, and a media player module 128 for providing a media player application. The user interface module 126 renders and displays the GUI of the device 101 in accordance with instructions of the operating system 122 and applications 124 (as applicable).

The modules 126, 128 may, among other things, each be implemented through stand-alone software applications, or combined together in one or more of the operating system 122 and applications 124. In some example embodiments, the functions performed by each of the above identified modules 126, 128 may be realized as a plurality of independent elements, rather than a single integrated element, and any one or more of these elements may be implemented as parts of other software applications.

Those skilled in the art will appreciate that the software modules 120 or parts thereof may be temporarily loaded into volatile memory such as the RAM 146. The RAM 146 is used for storing runtime data variables and other types of data or information, as will be apparent to those skilled in the art. Although specific functions are described for various types of memory, this is merely one example, and those skilled in the art will appreciate that a different assignment of functions to types of memory could also be used.

The software applications 124 may include a range of applications, including, for example, an address book application, a messaging application (i.e., SMS, MMS), a calendar application, drawing application (as explained in more detail below) and/or a notepad application. In some embodiments, the software applications 124 include an email message application, a push content viewing application, a voice communication (i.e. telephony) application, a map application, and a media player application. Each of the software applications 124 may include layout information defining the placement of particular fields and graphic elements (e.g. text fields, input fields, icons, etc.) in the user interface (i.e. the display device 104) according to the application. As described further below with particular reference to illustrative embodiments, the applications (or modules) are so configured to enable enhanced messaging functionality from either an in-call or call log UI. Such programming can be implemented by those skilled in the art based on the teachings herein.

In some embodiments, the auxiliary input/output (I/O) subsystems 150 may comprise an external communication link or interface, for example, an Ethernet connection. The mobile communication device 101 may comprise other wireless communication interfaces for communicating with other types of wireless networks, for example, a wireless network such as an orthogonal frequency division multiplexed (OFDM) network or a GPS transceiver for communicating with a GPS satellite network (not shown). The auxiliary I/O subsystems 150 may comprise a vibrator for providing vibratory notifications in response to various events on the mobile communication device 201 such as receipt of an electronic communication or incoming phone call, or for other purposes such as haptic feedback (touch feedback).

In some embodiments, the mobile communication device 101 also includes a removable memory card 130 (typically comprising flash memory) and a memory card interface 132. Network access typically associated with a subscriber or user of the mobile communication device 101 via the memory card 130, which may be a Subscriber Identity Module (SIM) card for use in a GSM network or other type of memory card for use in the relevant wireless network type. The memory card 130 is inserted in or connected to the memory card interface 132 of the mobile communication device 101 in order to operate in conjunction with the wireless network 101.

The mobile communication device 101 stores data 140 in an erasable persistent memory, which in one example embodiment is the flash memory 144. In various embodiments, the data 140 includes service data comprising information required by the mobile communication device 101 to establish and maintain communication with the wireless network. The data 140 may also include user application data such as email messages, address book and contact information, calendar and schedule information, notepad documents, image files, and other commonly stored user information stored on the mobile communication device 101 by its user, and other data. The data 140 stored in the persistent memory (e.g. flash memory 244) of the mobile communication device 101 may be organized, at least partially, into a number of databases each containing data items of the same data type or associated with the same application. For example, email messages, contact records, and task items may be stored in individual databases within the device memory.

The serial data port 152 may be used for synchronization with a user's host computer system (not shown). The serial data port 152 enables a user to set preferences through an external device or software application and extends the capabilities of the mobile communication device 101 by providing for information or software downloads to the mobile communication device 101 other than through the wireless network. The alternate download path may, for example, be used to load an encryption key onto the mobile communication device 101 through a direct, reliable and trusted connection to thereby provide secure device communication.

In some embodiments, the mobile communication device 101 is provided with a service routing application programming interface (API) which provides an application with the ability to route traffic through a serial data (i.e., USB) or Bluetooth® connection to the host computer system using standard connectivity protocols. When a user connects their mobile communication device 101 to the host computer system via a USB cable or Bluetooth® connection, traffic that was destined for the wireless network is automatically routed to the mobile communication device 101 using the USB cable or Bluetooth® connection. Similarly, any traffic destined for the wireless network 101 is automatically sent over the USB cable or Bluetooth® connection to the host computer system for processing.

The mobile communication device 101 also includes a battery 138 as a power source, which is typically one or more rechargeable batteries that may be charged, for example, through charging circuitry coupled to a battery interface such as the serial data port 152. The battery 138 provides electrical power to at least some of the electrical circuitry in the mobile communication device 101, and the battery interface 136 provides a mechanical and electrical connection for the battery 138. The battery interface 136 is coupled to a regulator (not shown) which provides power V+ to the circuitry of the mobile communication device 101.

The short-range communication subsystem 172 is an additional optional component which provides for communication between the mobile communication device 101 and different systems or devices, which need not necessarily be similar devices. For example, the subsystem 172 may include an infrared device and associated circuits and components, or a wireless bus protocol compliant communication mechanism such as a Bluetooth® communication module to provide for communication with similarly-enabled systems and devices.

A predetermined set of applications that control basic device operations, including data and possibly voice communication applications will normally be installed on the mobile communication device 101 during or after manufacture. Additional applications and/or upgrades to the operating system 121 or software applications 124 may also be loaded onto the mobile communication device 101 through the wireless network, the auxiliary I/O subsystem 150, the serial port 152, the short-range communication subsystem 172, or other suitable subsystem 174 other wireless communication interfaces. The downloaded programs or code modules may be permanently installed, for example, written into the program memory (i.e. the flash memory 144), or written into and executed from the RAM 146 for execution by the processor 140 at runtime. Such flexibility in application installation increases the functionality of the mobile communication device 101 and may provide enhanced on-device functions, communication-related functions, or both. For example, secure communication applications may enable electronic commerce functions and other such financial transactions to be performed using the mobile communication device 101.

The mobile communication device 101 may provide two principal modes of communication: a data communication mode and an optional voice communication mode. In the data communication mode, a received data signal such as a text message, an email message, or Web page download will be processed by the communication subsystem 111 and input to the processor 140 for further processing. For example, a downloaded Web page may be further processed by a browser application or an email message may be processed by an email message application and output to the display 142. A user of the mobile communication device 101 may also compose data items, such as email messages, for example, using the touch-sensitive overlay 106 in conjunction with the display device 104 and possibly the control buttons 160 and/or the auxiliary I/O subsystems 150. These composed items may be transmitted through the communication subsystem 111 over the wireless network.

In the voice communication mode, the mobile communication device 101 provides telephony functions and operates as a typical cellular phone. The overall operation is similar, except that the received signals would be output to the speaker 156 and signals for transmission would be generated by a transducer such as the microphone 122. The telephony functions are provided by a combination of software/firmware (i.e., the voice communication module) and hardware (i.e., the microphone 122, the speaker 156 and input devices). Alternative voice or audio I/O subsystems, such as a voice message recording subsystem, may also be implemented on the mobile communication device 101. Although voice or audio signal output is typically accomplished primarily through the speaker 156, the display device 104 may also be used to provide an indication of the identity of a calling party, duration of a voice call, or other voice call related information.

The touchscreen display 110 can be any suitable touchscreen display such as a capacitive touchscreen display. A capacitive touchscreen display 110 includes the display device 104 and the touch-sensitive overlay 106, in the form of a capacitive touch-sensitive overlay 106. It will be appreciated that the capacitive touch-sensitive overlay 106 includes a number of layers in a stack and is fixed to the display device 104 via a suitable optically clear adhesive. The layers can include, for example a substrate fixed to the display device 104 (e.g. LCD display) by a suitable adhesive, a ground shield layer, a barrier layer, a pair of capacitive touch sensor layers separated by a substrate or other barrier layer, and a cover layer fixed to the second capacitive touch sensor layer by a suitable adhesive. The capacitive touch sensor layers can be any suitable material such as patterned indium tin oxide (ITO).

Each of the touch sensor layers comprises an electrode layer each having a number of spaced apart transparent electrodes. The electrodes may be a patterned vapour-deposited ITO layer or ITO elements. The electrodes may be, for example, arranged in an array of spaced apart rows and columns. As shown in FIG. 5, the touch sensor layers/electrode layers are each associated with a coordinate (e.g., x or y) in a coordinate system used to map locations on the touchscreen display 110, for example, in Cartesian coordinates (e.g., x and y-axis coordinates). The intersection of the rows and columns of the electrodes may represent pixel elements defined in terms of an (x, y) location value which can form the basis for the coordinate system. Each of the touch sensor layers provide a signal to the controller 108 which represent the respective x and y coordinates of the touchscreen display 110. That is, x locations are provided by a signal generated by one of the touch sensor layers and y locations are provided by a signal generated by the other of the touch sensor layers.

The electrodes in the touch sensor layers/electrode layers respond to changes in the electric field caused by conductive objects in the proximity of the electrodes. When a conductive object is near or contacts the touch-sensitive overlay 106, the object draws away some of the charge of the electrodes and reduces its capacitance. The controller 108 receives signals from the touch sensor layers of the touch-sensitive overlay 106, detects touch events by determining changes in capacitance which exceed a predetermined threshold, and determines the centroid of a contact area defined by electrodes having a change in capacitance which exceeds the predetermined threshold, typically in x, y (Cartesian) coordinates.

The controller 108 sends the centroid of the contact area to the processor 140 of the device 101 as the location of the touch event detected by the touchscreen display 110. Depending on the touch-sensitive overlay 106 and/or configuration of the touchscreen display 110, the change in capacitance which results from the presence of a conductive object near the touch-sensitive overlay 106 but not contact the touch-sensitive overlay 106, may exceed the predetermined threshold in which case the corresponding electrode would be included in the contact area. The detection of the presence of a conductive object such as a user's finger or a conductive stylus is sometimes referred to as finger presence/stylus presence.

It will be appreciated that other attributes of a touch event on the touchscreen display 110 can be determined. For example, the size and the shape (or profile) of the touch event on the touchscreen display 110 can be determined in addition to the location based on the signals received at the controller 108 from the touch sensor layers. For example, the touchscreen display 110 may be used to create a pixel image of the contact area created by a touch event. The pixel image is defined by the pixel elements represented by the intersection of electrodes in the touch sensor layers/electrode layers. The pixel image may be used, for example, to determine a shape or profile of the contact area.

The centroid of the contact area is calculated by the controller 108 based on raw location and magnitude (e.g., capacitance) data obtained from the contact area. The centroid is defined in Cartesian coordinates by the value (X_{c}, Y_{c}). The centroid of the contact area is the weighted averaged of the pixels in the contact area and represents the central coordinate of the contact area. By way of example, the centroid may be found using the following equations:

$$\begin{matrix}{X}_{c} = \frac{{\sum }_{i = 1}^{n} {Z}_{i} * {x}_{i}}{{\sum }_{i = 1}^{n} {Z}_{i}} & ( 1 ) \\ {Y}_{c} = \frac{{\sum }_{i = 1}^{n} {Z}_{i} * {y}_{i}}{{\sum }_{i = 1}^{n} {Z}_{i}} & ( 2 )\end{matrix}$$

where X_{c} represents the x-coordinate of the centroid of the contact area, Y_{c} represents the y-coordinate of the centroid of the contact area, x represents the x-coordinate of each pixel in the contact area, y represents the y-coordinate of each pixel in the contact area, Z represents the magnitude (capacitance value or resistance) at each pixel in the contact area, the index i represents the electrodes in the contact area and n represents the number of electrodes in the contact area. Other methods of calculating the centroid will be understood to persons skilled in the art.

The controller 108 of the touchscreen display 110 is typically connected using both interpret and serial interface ports to the processor 140. In this way, an interrupt signal which indicates a touch event has been detected, the centroid of the contact area, as well as raw data regarding the location and magnitude of the activated electrodes in the contact area are passed to the processor 140. However, in other example embodiments only an interrupt signal which indicates a touch event has been detected and the centroid of the contact area are passed to the processor 140. In embodiments where the raw data is passed to the processor 140, the detection of a touch event (i.e., the application of an external force to the touch-sensitive overlay 106) and/or the determination of the centroid of the contact area may be performed by the processor 140 of the device 101 rather than the controller 108 of the touchscreen display 110.

In other embodiments, the touchscreen display 110 may be a display device, such as an LCD screen, having the touch-sensitive input surface (overlay) 106 integrated therein. One example of such a touchscreen is described in commonly owned U.S. patent publication no. 2004/0155991, published Aug. 12, 2004 (also identified as U.S. patent application Ser. No. 10/717,877, filed Nov. 20, 2003) which is incorporated herein by reference.

While a specific embodiment of the touchscreen display 110 has been described, any suitable type of touchscreen in the handheld electronic device of the present disclosure including, but not limited to, a capacitive touchscreen, a resistive touchscreen, a surface acoustic wave (SAW) touchscreen, an embedded photo cell touchscreen, an infrared (IR) touchscreen, a strain gauge-based touchscreen, an optical imaging touchscreen, a dispersive signal technology touchscreen, an acoustic pulse recognition touchscreen or a frustrated total internal reflection touchscreen. The type of touchscreen technology used in any given embodiment will depend on the handheld electronic device and its particular application and demands.

The mobile communication device 101 also comprises a device orientation subsystem 149 comprising at least one orientation sensor which is connected to the processor 140 and which is controlled by one or a combination of a monitoring circuit and operating software. The device orientation subsystem 149 may comprise two or more orientation sensors or an orientation sensor and an electronic compass. The device orientation subsystem 149 detects the orientation of the mobile communication device 101 or detects information which the orientation of the mobile communication device 101 can be determined, such as acceleration using an accelerometer. In other embodiments, an orientation sensor other than an accelerometer could be used, such as a gravity sensor, a gyroscope, a tilt sensor, an electronic compass, or other suitable sensor, or combinations thereof.

As will be appreciated by persons skilled in the art, an accelerometer is a sensor which converts acceleration from motion (e.g. movement of the mobile communication device 101 or a portion thereof due to the strike force) and gravity which are detected by a sensing element into an electrical signal (producing a corresponding change in output) and is available in one, two or three axis configurations. Accelerometers may produce digital or analog output signals depending on the type of accelerometer. Generally, two types of outputs are available depending on whether an analog or digital accelerometer used: (1) an analog output requiring buffering and analog-to-digital (A/D) conversion; and (2) a digital output which is typically available in an industry standard interface such as an SPI (Serial Peripheral Interface) or I2C (Inter-Integrated Circuit) interface. The output of an accelerometer is typically measured in terms of the gravitational acceleration constant at the Earth's surface, denoted g, which is approximately 9.81 m/s² (32.2 ft/s²) as the standard average. The accelerometer may be of almost any type including, but not limited to, a capacitive, piezoelectric, piezoresistive, or gas-based accelerometer. The range of accelerometers vary up to the thousands of g's, however for portable electronic devices “low-g” accelerometers may be used. Example low-g accelerometers which may be used are MEMS digital accelerometers from Analog Devices, Inc. (ADI), Freescale Semiconductor, Inc. (Freescale) and STMicroelectronics N.V. of Geneva, Switzerland.

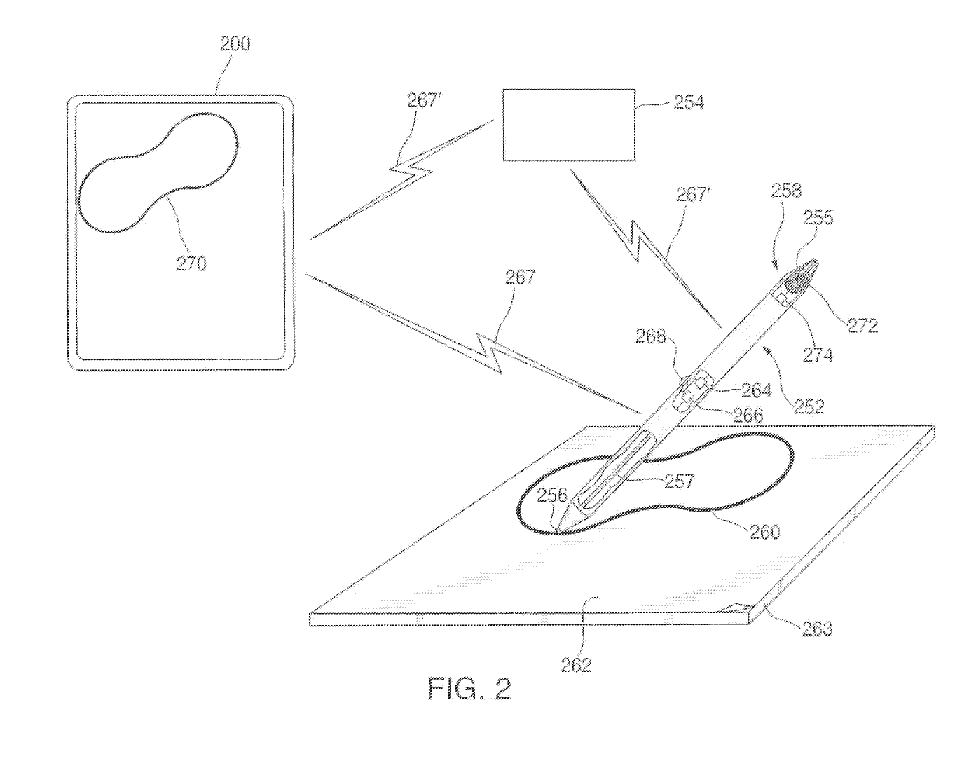

In accordance with an aspect of the disclosure, FIG. 2 depicts a schematic of a digital drawing system 250 comprising an electronic device 200 (of the type disclosed above, or any computing device capable of rendering a digital image on a display), and a digital pen (electronic drawing device) 252 configured to electronically communicate with device 200. The pen 252 may couple to the device 200 using a variety of methods, including directly transmitting signals to device 200 over a short-range communications protocol such as, including but not limited to, Bluetooth®, Ultra-Wideband (UWB), IrDA, ZigBee, WiFi (802.11). Alternatively, pen 252 may communicate with an intermediate device 254 that stores information corresponding to pen movement, and which processes the information and sends signals representative of the pen movement and characteristics to device 200. Although illustratively shown as a wireless connection, a physical connection such as USB could be employed as well. As shown generally in an illustrative embodiment, the pen 252 comprises a ball-point tip 256 at one end thereof coupled to an ink reservoir 257, and an eraser element 258 disposed at the opposite end thereof. The ball-point tip 256 renders a conventional drawing 260 on a sheet of paper 262. The paper sheet 262 is mounted on a support 263 housing a control circuit configured for resolving the position of the pen relative to the paper and mode of operation (draw/erase). Alternatively, the pen 252 includes the control circuit 264 for converting information corresponding to the drawn subject matter 260 into digital format, and a transmitter 266 that transmits encoded signals 267′ via an antenna 268 to a receiver in device 254, or directly (267) to device 200. The signals are either processed by device 254 or an application executing on device 200 to render a digital representation 270 on a display 210 of device 200. In accordance with an aspect of the invention, the eraser element 258 of pen 252 comprises a bleaching-agent 255 (white-out or like material) stored in a reservoir 272 connected to an eraser sensor 274. The bleaching agent is dispensed from the end of pen 252 onto paper 262 to edit the paper drawing 260. The eraser sensor 274 is operatively coupled to the control circuit 264 such that signals representative or an erasing function are transmitted to device 200 to effectuate simultaneous erasure of the portion of the digital representation 270 corresponding to the corrected part of the actual drawing 260. In this manner, the device 200 executing the drawing application erases any line/object in the digital drawing at substantially the same time the corresponding component is physically edited on paper. The control circuit 264 can be configured to respond to an accelerometer such that it senses when the pen is in the erasure mode by turning the pen upside down. Alternatively, the control circuit can be adapted to sense either when ink is being dispensed through the ball point 256 or bleaching agent 255 is being dispensed from reservoir 272. Furthermore, although the eraser element 258 is advantageously included as part of the pen 252, it will be appreciated by those skilled in the art that a separate pen-like implement may be configured to provide such an erasing function in lieu of a dual-action pen as shown and described. For example, a dedicated eraser may comprise separate control circuitry coupled to the eraser element as described above. The control circuitry in this instance is configured to only resolve erasing movements on the paper drawing and resolve these into digital signals instructing the device 200 to effect such changes on the digital rendition. It will be appreciated by those skilled in the art that although shown and described as an ink pen, the present disclosure may encompass any other type of physical writing implement/eraser configuration within the scope thereof.

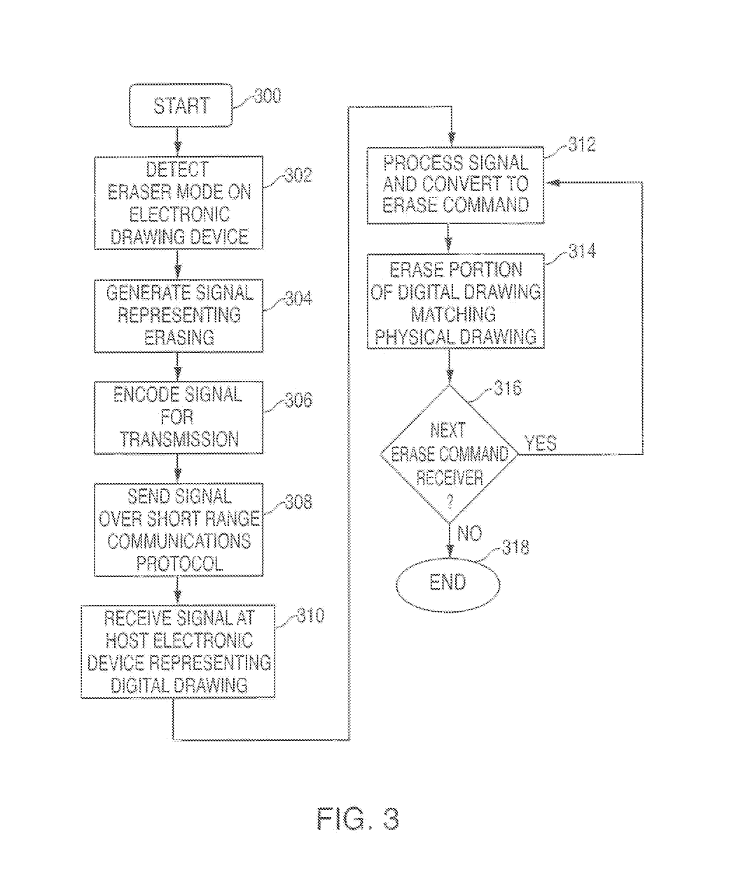

FIG. 3 is a flow-diagram of a process 300 for implementing aspects of the disclosure. In block 302 the electronic drawing device enters an eraser mode in response to either selecting an eraser function or automatically by detecting motion via an accelerometer. A bleaching agent is dispensed on the physical drawing and sensed by the control circuit. The control circuit then generates at least one signal representative of the erasing at block 304. This signal(s) is then encoded for transmission at block 306 and sent via a short range communications protocol at block 308 to the host electronic device, either directly or via an intermediate electronic device as described above. At block 301, the signal is received by the host electronic device and processed into an erase command at block 312. At block 314, the drawing application then erases a portion of the digital drawing corresponding to the edits made to the physical drawing with the bleaching agent dispensed from the eraser of the electronic drawing device. If no additional erasing commands are received at block 316, the process terminates at block 318.

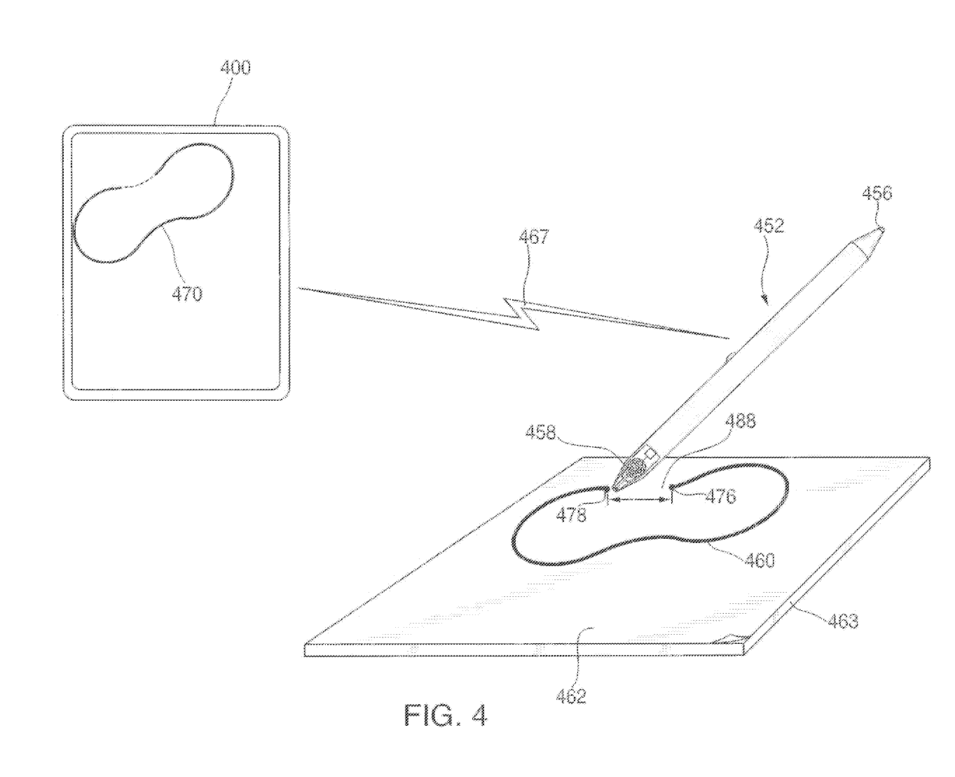

FIG. 4 is a schematic of a pen 452 in the eraser mode with the eraser 454 thereof dispensing a bleaching agent 455 from reservoir 472 onto the paper drawing 460 on paper 462 mounted on support 463. As the bleaching agent “whites out”/erases a portion of the drawing 460 shown by the arrow between points 476 and 478, the corresponding portion of the digital representation 470 on the display of the host electronic device 400 is erased (shown in phantom) by the process described above between points 476′ and 478′.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

I claim:

1. A method of editing a digital representation on a host electronic device of a physical drawing using an electronic drawing device configured to edit the physical drawing, comprising the steps of:
erasing at least a portion of the physical drawing on a physical medium;
generating at least one signal representative of the erasing; and
processing the at least one signal to produce an output that may be processed by the host electronic device to edit the digital representation corresponding to the erasing.

2. The method of claim 1, wherein at least one signal representative of the erasing is transmitted from the electronic drawing device to the host electronic device.

3. The method of claim 2, wherein the at least one signal is transmitted to the host electronic device via an intermediate device configured to process the at least one signal.

4. The method of claim 1, wherein the erasing at least a portion of the physical drawing is by a bleaching agent.

5. The method of claim 4, wherein the generating includes sensing the bleaching agent being dispensed from the electronic drawing device.

6. The method of claim 1, further comprising the host electronic device executing a drawing application responsive to signals received from the electronic drawing device.

7. The method of claim 6, wherein the drawing application controls a display to render and edit the digital representation.

8. An electronic drawing system configured to edit a physical drawing and communicate the edit to a host electronic device that renders a digital rendition of the physical drawing, comprising:
a control circuit configured to communicate with an element that enables erasing at least a portion of the physical drawing, the control circuit further configured to generating at least one signal representative of the erasing, the at least one signal capable of being processed to edit the digital representation corresponding to the erasing.

9. The electronic drawing system of claim 8, further comprising a transmitter coupled to the control circuit.

10. The electronic drawing system of claim 8, further comprising a reservoir configured for storing an erasing medium.

11. The electronic drawing system of claim 8, further comprising a ball point tip on end thereof and an erasing medium, the ball point tip connected to an ink reservoir.

12. The electronic drawing system of claim 11, wherein the ball point tip and erasing medium are substantially disposed on opposite ends thereof.

13. The electronic drawing system of claim 10, wherein the reservoir is operatively coupled to a sensor communicating with the control circuit.

14. The electronic drawing system of claim 8, wherein the control circuit is configured to communicate signals to a processing device for resolving the erasing into signals that may be read by the host electronic device.

15. The electronic device of system 8, wherein the electronic drawing device communicates the at least one signal using a short range communications protocol.
